(19) United States
(12) Patent Application Publication
(10) Pub. No.: US 2004/0095473 A1
(43) Pub. Date: May 20, 2004

(54) Image-capturing device capable of adjusting view angles and a control method therefor

(76) Inventor: Jong-Tae Park, Suwon-city (KR)

Correspondence Address: Christian C. Michel, Roylance, Abrams, Berdo & Goodman, L.L.P., Suite 600, 1300 19th Street, N.W., Washington, DC, 20036, US

(21) Appl. No.: 10/697,979

(22) Filed: Oct. 31, 2003

(30) Foreign Application Priority Data
Nov. 20, 2002 (KR) 2002-72564

(51) Int. Cl. H04N 5/228; H04N 7/18; H04N 5/262; H04N 9/47

(52) U.S. Cl. 348/220.1; 348/240.99; 348/64

(57) ABSTRACT

Disclosed is an image-capturing device and a control method therefor capable of adjusting view angles. The image-capturing device comprises a camera part having a first camera adapted to capture images of a subject through a first zoom lens if a first image-capturing mode is selected, and a second camera adapted to capture images through a second zoom lens if a second image-capturing mode is selected The image capturing device also includes a detection unit for detecting the position of the first and the second zoom lenses. A control unit detects the position of the first and the second zoom lenses for the first and the second image-capturing modes if the image-capturing modes are determined to be changed from the first to the second image-capturing mode, and sets a detected value of the position of the first zoom lens to a value of the position of the second zoom lens. The image-capturing device can advantageously eliminate the inconvenience of having to additionally adjusts view angles when changing lenses.

### CROSS-REFERENCE TO RELATED APPLICATIONS

This application claims the benefit of Korean Application No. 2002-72564, filed Nov. 20, 2002, in the Korean Intellectual Property Office, the entire contents of which is incorporated herein by reference in its entirety.

### BACKGROUND OF THE INVENTION

1. Field of the Invention

The present invention relates to an image-capturing device and a control method therefore. More particularly, the present invention relates to an image-capturing device and a control method therefor for adjusting view angles to be changed together with lens replacements when lenses for capturing pictures of subjects are replaced.

2. Description of the Prior Art

A digital video camera (DVC) is an image-capturing device for primarily recording and reproducing moving pictures. Typically, still images can be captured by a DVC, but the image quality becomes deteriorated compared to a digital still camera (DSC). Further, the digital still camera primarily records and reproduces still images since it has an image recording medium of small capacity.

Digital image-capturing devices such as digital still cameras, digital video cameras, and so on, have become popular, and have achieved widespread acceptance in recent years. Recent trends show that users tend to use a digital video camera together with a digital still camera. Accordingly, an image-capturing device performing the functions of a digital still camera by use of a digital video camera has been developed.

FIG. 1 is a block diagram for showing a conventional image-capturing device combining functions of a digital video camera with functions of a digital still camera.

FIG. 1 shows an image-capturing device 100 that has an input unit 105, a DVC lens unit 110, a lens driving unit 115, an image-capturing unit 120, a signal conversion unit 125, a buffer 130, a still image codec unit 135, a flash memory 140, a moving picture codec unit 145, a tape 150, and a control unit 155.

The input unit 105 is provided with an image-capturing key 105a for selecting a still image mode, a recording key 105b for selecting a moving picture mode, and plural keys (not shown) for manipulating the image-capturing device 100.

The DVC lens unit 110 consists of a zoom lens for enlarging and/or reducing a subject, and a focus lens for adjusting the focus depending upon subject and zoom lens positions.

The lens driving unit 115 is a motor for moving the zoom lens and/or focus lens according to the control of the control unit 155 which will be described later.

The image-capturing unit 120 converts an image signal of a subject through the DVC lens unit 110 into an electronic signal by use of a charge coupled device.

The signal conversion unit 125 removes noise included in an electronic signal generated by the image-capturing unit 120 and amplifies a gain in order for the level of an image signal converted into an electronic signal to be uniformly outputted. Further, the signal conversion unit 125 converts the analog image signal generated by the image capturing device 120 into a digital image signal.

The buffer 130 temporarily stores a signal outputted from the signal conversion unit 125.

The still image codec unit 135 compresses a still image signal received from the buffer 130 by use of a coding format such as JPEG. Compressed still image coding data is stored in the flash memory 140. Further, the still image codec unit 135 decompresses the coding data stored in the flash memory 140 under the control of the control unit 155 if the input unit 105 receives a reproducing command signal.

The moving picture codec unit 145 compresses a moving picture signal received from the buffer 130 under the control of the control unit 155 by use of a coding format such as MPEG. Compressed moving picture coding data is stored in the tape 150. Further, the moving picture codec unit 145 decompresses the coding data stored in the tape 150 under the control of the control unit 155 if the input unit 105 receives a reproducing command signal.

The control unit 155 enables an image signal of a subject stored in the buffer 130 to be stored in the flash memory 140 or the tape 150 based on a signal according to the selection of the image-capturing key 105a and the recording key 105b.

However, the conventional image-capturing device 100 described as above captures moving pictures as its main function and still images as its extra function. As a result, conventional DVCs capture and store images that have a resolution and image quality that are excellent for moving pictures, but which are poor for still images, relative to stand along digital still cameras.

Accordingly, a combination-type image-capturing device (not shown) combining a digital still camera and a digital video camera has been developed. However, the digital still camera and the digital video camera often have different view angles for image-capturing from each other. Thus, if a user wants to capture moving pictures of a subject by use of the digital video camera in the middle of taking still images using of the digital still camera, the user inconveniently needs to adjusts a view angle in order to make the image-capturing view angle for the digital still camera equal to the image-capturing view angle for the digital video camera. This causes unnecessary inconvenience for the user.

### SUMMARY OF THE INVENTION

Accordingly, it is an aspect of the present invention to provide an image-capturing device and a control method therefor capable of adjusting view angles, to thereby solve the inconvenience of additionally adjusting view angles when lenses used for capturing pictures of a subject are swapped.

In order to achieve the above aspect, an image-capturing device according to the present invention comprises a camera part, a mode sensing unit, a detection unit, a control unit, and a storage unit.

The camera part has a first camera for capturing images of a subject at a position of a first zoom lens if a first image-capturing mode is selected, and a second camera for capturing images of the subject at a position of a second zoom lens if a second image-capturing mode is selected. The camera part is provided on a main body thereof to rotate by a certain angle. The mode sensing unit senses an image-capturing mode corresponding to rotations of the camera part. The detection unit detects the position of the first zoom lens for the first image-capturing mode and the position of the second zoom lens for the second image-capturing mode. The control unit controls the detection unit to detect the position of the first zoom lens previously selected for the first image-capturing mode. The control unit also controls the detection unit to detect the position of the second zoom lens subsequently selected for the second image-capturing mode if the image-capturing modes are decided to be selected and changed from the first image-capturing mode to the second image-capturing mode based on an output signal of the mode sensing unit. The control unit compares the positions of the first and second zoom lenses detected from the detection unit, and, if it is determined that the positions are different, the control unit sets a value of the position of the first zoom lens to a value of the position of the second zoom lens. The storage unit is detachably mounted on the main body, and stores an image signal for the subject image-captured through the first and second cameras.

In more detail, the image-capturing device further comprises a view angle calculation unit for calculating view angles for the positions of the first and second zoom lenses respectively. Also, the control unit decides whether the magnifications of the first and second zoom lenses corresponding to the first and second image-capturing modes respectively are the same. If the magnifications of the first and second zoom lenses are determined to be different, the control unit compares view angles sequentially calculated from the view angle calculation unit with a previously calculated view angle of the first zoom lens while moving the second zoom lens in a certain direction. The control unit then sets a value of the position of the second zoom lens, the position indicating a minimum value in a view angle difference between the first and second zoom lenses.

Further, the first camera is preferably a digital still camera for capturing still images in the first image-capturing mode. The second camera is a digital video camera for capturing moving pictures in the second image-capturing mode. The first and the second cameras are preferably disposed opposite to each other.

In the meantime, in order to achieve the above and other aspects of the invention, a control method for an image-capturing device, according to an embodiment of the present invention, comprises the step of detecting the position of the first zoom lens previously selected for the first image-capturing mode. If the image-capturing modes are decided to be selected and changed from the first image-capturing mode to the second image-capturing mode based on an output signal of the mode sensing unit, the control method further comprises detecting the position of the second zoom lens subsequently selected for the second image-capturing mode, and setting a value of the position of the first zoom lens to a value of the position of the second zoom lens if the positions of the first and second zoom lenses detected from the detection unit are compared to each other and determined to be different from each other.

In more detail, the control method further comprises deciding whether the magnifications of the first and second zoom lenses corresponding to the first and second image-capturing modes respectively are the same. If the image-capturing modes are decided to be selected and changed from the first image-capturing mode to the second image-capturing mode based on an output signal of the mode sensing unit, the control method includes calculating view angles for the positions of the first and second zoom lenses, respectively. If the magnifications of the first and second zoom lenses are decided to be different, comparing sequentially calculated view angles with a previously calculated view angle of the first zoom lens while moving the second zoom lens in a certain direction. The control method also preferably includes setting a value of the position of the second zoom lens, the position indicating a minimum value in a view angle difference between the view angle of the first zoom lens and the sequentially calculated view angles of the second zoom lens.

### BRIEF DESCRIPTION OF THE DRAWINGS

The invention will be described in detail with reference to the following drawing figures in which like reference numerals refer to like elements, and wherein:

FIG. 1 is a block diagram showing a conventional image-capturing device combining functions of a digital video camera with those of a digital still camera;

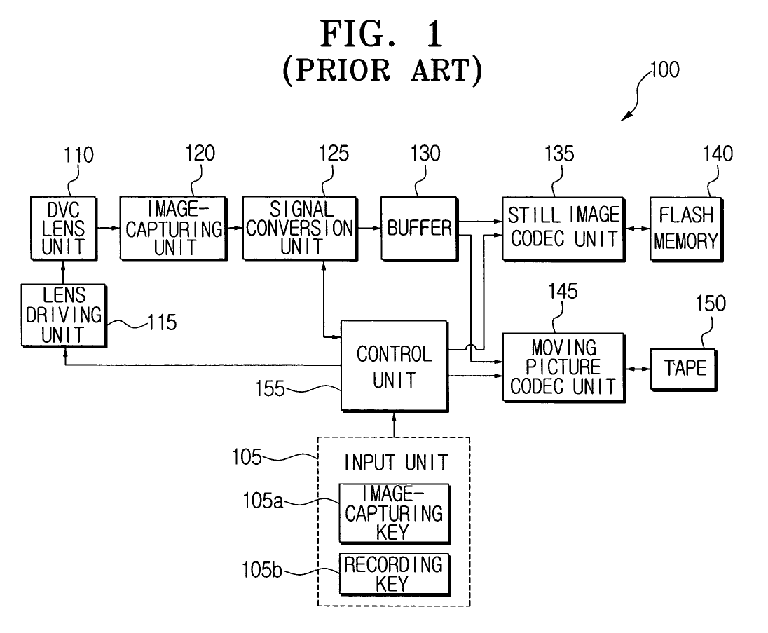

FIG. 2 is a perspective view showing an image-capturing device combining a digital still camera with a digital video camera according to an embodiment of the present invention;

FIG. 3 is a block diagram for showing the image-capturing device of FIG. 2;

FIG. 4 is a perspective view schematically showing an exemplary turnover switch for a mode sensing unit shown in FIG. 3; and

FIG. 5 is a flow chart illustrating a method for controlling a control unit adjusting image-capturing view angles for the image-capturing device when image-capturing modes are changed, as illustrated in FIG. 3.

### DETAILED DESCRIPTION OF THE PREFERRED EMBODIMENT

Hereinafter, an embodiment of the present invention will be described with reference to the accompanying drawing figures.

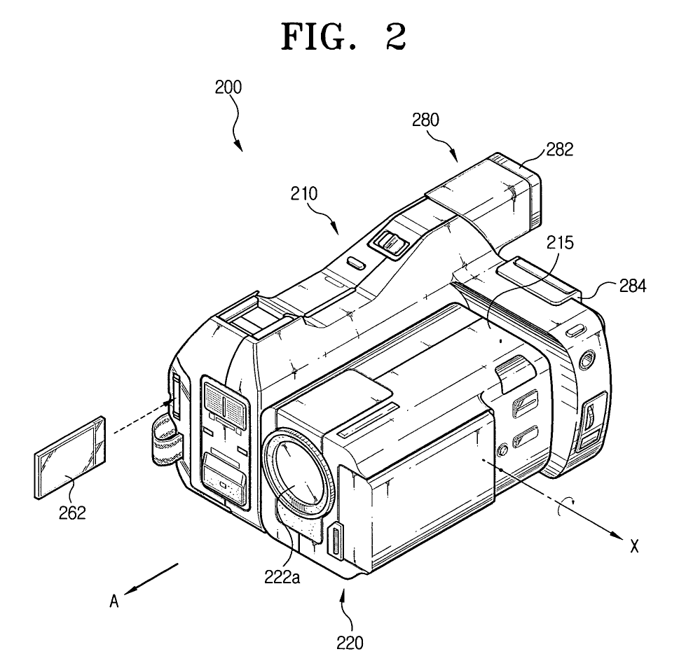

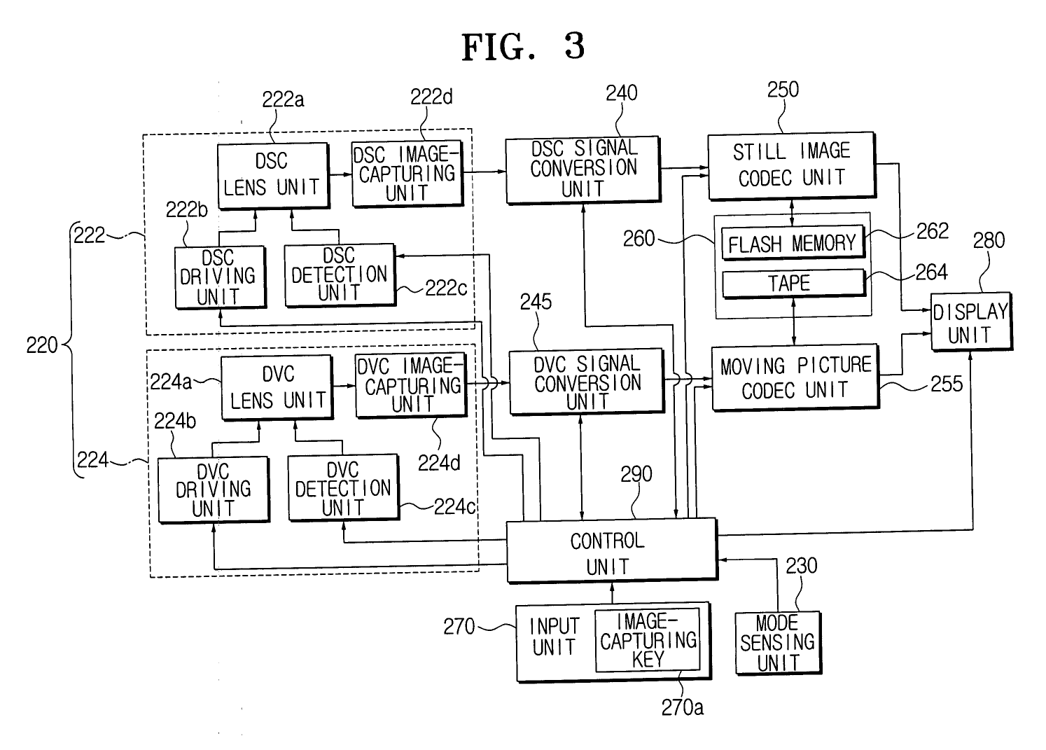

FIG. 2 is a perspective view illustrating an image-capturing device combining a digital still camera with a digital video camera according to an embodiment of the present invention. FIG. 3 is a block diagram schematically showing the image-capturing device shown in FIG. 2.

Referring to FIG. 2 and FIG. 3, an image-capturing device 200 according to an embodiment of the present invention has a main body 210, a camera part 220, a mode sensing unit 230, a DSC signal conversion unit 240, a DVC signal conversion unit 245, a still image codec unit 250, a moving picture codec unit 255, a storage unit 260, an input unit 270, a display unit 280, and a control unit 290.

The camera part 220 is provided with a housing 215 mounted to rotate in a predetermined range of angles. The camera part 220 also preferably includes a first camera 222 (hereinafter, referred to as “DSC”) for capturing still images, and a second camera 224 (hereinafter, referred to as “DSC”) for capturing moving pictures.

The DSC 222 and the DVC 224 are preferably disposed opposite to each other. In other words, as shown in FIG. 2, a DSC lens unit 222a of the DSC 222 is mounted at one end of the housing 215 to face an image-capturing direction, and a DVC lens unit 224a (not visible in FIG. 2) of the DVC 224 is mounted on the opposite end of the housing 215.

Accordingly, the camera part 220 rotates in a certain angle in clockwise or counterclockwise direction about a rotation axis X, but it is preferable that the DSC lens unit 222a and the DVC lens unit 224a rotate by an angle at which they maintain parallel with the image-capturing direction. That is, if the housing 215 manually rotates 180° in FIG. 2, it is preferable that the positions of the DSC lens unit 222a and the DVC lens unit 224a are exchanged with each other.

Preferably, either the DSC lens unit 222a or the DVC lens unit 224a of the camera part 220 can capture images in all the rotation angles. That is, a range of −360° to +360°. For example, the camera part 220 can capture images of a subject even though the lengthwise direction of the camera part 220 rotates to be perpendicular to the lengthwise direction of the main body 210.

As illustrated in FIG. 3, the DSC 222 has the DSC lens unit 222a, a DSC driving unit 222b, a DSC detection unit 222c, and a DSC image-capturing unit 222d.

The DSC lens unit 222a is for capturing still images, and has at least one first zoom lens (hereinafter, referred to as “DSC zoom lens”) for enlarging and/or reducing a subject, and at least one first focus lens (hereinafter, referred to as “DSC focus lens”) (not shown) for adjusting the focus depending upon a distance between a subject and the DSC zoom lens.

The DSC driving unit 222b moves the DSC zoom lens (not shown) and the DSC focus lens according to controls of the control unit 290 which will be described in further detail below.

The DSC detection unit 222c is a sensor for detecting positions of the DSC zoom lens and the DSC focus lens according to the controls of the control unit 290. The DSC detection unit 222c is preferably constructed using a photo interrupter, or the like.

The DSC image-capturing unit 222d converts into an analog electrical image signal an image signal of a subject through the DSC zoom lens (not shown) and the DSC focus lens (not shown) by use of charge coupled devices.

The DSC 222 captures images of a subject at a view angle for a position of the DSC zoom lens (not shown) if the camera is turned over by a user to capture images of a subject, that is, if a first image-capturing mode (for example, a still image mode) is selected.

The DVC 224 has the DVC lens unit 224a, a DVC driving unit 224b, a DVC detection unit 224c, and a DVC image-capturing unit 224d.

The DVC lens unit 224a is for capturing moving pictures, and has at least one second zoom lens (hereinafter, referred to as “DVC zoom lens”) (not shown) for enlarging and/or reducing a subject and at least one second focus lens (hereinafter, referred to as “DVC focus lens”) (not shown) for adjusting the focus according to a distance between a subject and the DVC zoom lens.

The DVC driving unit 224b moves the DVC zoom lens (not shown) and the DVC focus lens (not shown) according to controls of the control unit 290 which will be described in further detail below.

The DVC detection unit 224c is a sensor for detecting the positions of the second zoom lens (not shown) and the second focus lens (not shown) according to controls of the control unit 290. The DVC detection unit 224c is preferably constructed using a photo interrupter, or the like.

The DVC image-capturing unit 224c converts into an analog electrical image signal an image signal of a subject through the DVC zoom lens (not shown) and the DVC focus lens (not shown) by use of charge coupled devices.

The DVC 224 captures images of a subject at a view angle for a position of the DVC zoom lens (not shown), if the camera is turned over by a user to capture images of a subject, that is, if a second image-capturing mode (for example, a moving picture mode) is selected.

The mode sensing unit 230 senses an image-capturing mode in correspondence to the rotation of the camera part 220. The mode sensing unit 230 senses an image-capturing mode corresponding to the DSC 222 and the DVC 224 according to a rotation angle of the camera unit 220. Hereinafter, a mode for capturing images of a subject by the DSC 222 is referred to as a first image-capturing mode (hereinafter, also referred to as “still image mode”), and a mode for capturing images of a subject by the DVC 224 is referred to as a second image-capturing mode (hereinafter, also referred to as “moving picture mode”).

The mode sensing unit 230 may be implemented by a turnover switch which turns off either the DSC 222 or the DVC 224 and turns on the other depending upon rotations of the camera 220.

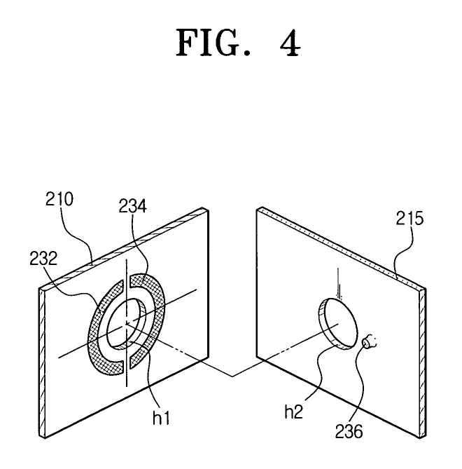

FIG. 4 is a perspective view for schematically showing an exemplary turnover switch for the mode sensing unit shown in FIG. 3.

Referring to FIG. 4, the turnover switch includes first and second contact patterns 232 and 234 provided on the main body 210 and a contact terminal 236 provided on the housing 215 to come in contact with either the first or the second contact pattern 232 or 234. The main body 210 and the housing 215 are coupled to rotate relative to each other with openings h1 and h2 facing each other. Accordingly, the contact terminal 236 comes in contact with the first contact pattern 232 or the second contact pattern 234 depending upon rotation angles of the housing 215 with respect to the main body 210.

For purposes of the description contained herein, it is assumed that the first contact pattern 232 is connected to the DSC 222 and the second contact pattern 234 is connected to the DVC 224. At this time, if the contact terminal 236 is located at a position where it contacts with the first contact pattern 232, the DSC 222 turns on, and the DVC 224 turns off. Accordingly, a subject is captured by the DSC 222, and the control unit 290 decides an image-capturing mode as a still image mode.

Referring back to FIG. 2 and FIG. 3, the main body 210 has the DSC signal conversion unit 240, DVC signal conversion unit 245, still image codec unit 250, moving picture codec unit 255, storage unit 260, input unit 270, display unit 280, and control unit 290 therein.

The DSC signal conversion unit 240 and the DVC signal conversion unit 245, respectively, remove noise included in signals received from the DSC image-capturing unit 222d and the DVC image-capturing unit 224d. The DSC signal conversion unit 240 and the DVC signal conversion unit 245 also amplify gain so that the levels of the converted image signals are generated evenly. Further, the DSC signal conversion unit 240 and the DVC signal conversion unit 245, respectively, convert analog image signals into digital image signals, and generate automatic control data through a digital process.

The still image codec unit 250 compresses a still image signal outputted from the DSC signal conversion unit 240 by controls of the control unit 290 by use of a compression format such as JPEG. The compressed still image data is stored in a storage medium such as the flash memory 262 of the storage unit 260.

The moving picture codec unit 255 compresses a moving picture signal outputted from the DVC signal conversion unit 245 by controls of the control unit 290 by using a compression format such as MPEG. The compressed moving picture data is stored in a storage medium such as the tape 264 of the storage unit 260.

Further, if the input unit 270 receives a reproducing command signal for a stored image signal, the still image codec unit 250 and the moving picture codec unit 255 decompresses coded data stored in the flash memory 262 and the tape 264, respectively, under controls of the control unit 290. The input unit 270 will be described in further detail below.

For example, if the input unit 270 receives a reproducing command signal for a still image, the still image codec unit 250 decompresses coded data for a still image stored in the flash memory 262 and sends the decoded signal to the display unit 280.

The input unit 270 has an image-capturing key 270a for applying to the control unit 290 an image-capturing command signal for a subject, and manipulation buttons (not shown) for implementing other functions.

The display unit 280 has a view finder 282 or an LCD panel 284 which is provided on one end of the main body 210. The display unit 280 displays captured or decompressed images through the DSC 222 or the DVC 224 under controls of the control unit 290.

The control unit 290 controls the overall operations of the image-capturing device by using various control programs stored in the storage unit 260 and automatic control data outputted from the DSC signal conversion unit 240 or the DVC signal conversion unit 245.

The control unit 290 determines an image-capturing mode based on an output signal of the mode sensing unit 230, and drives the camera part 220 corresponding to the determined image-capturing mode. For example, if a signal indicating that the camera is in still image mode is received from the mode sensing unit 230, the control unit 290 determines that the image-capturing mode of the camera part 220 is a still image mode.

Further, if an image-capturing command signal is applied from the image-capturing key 270a, the control unit 290 drives the DSC 222 corresponding to the still image mode. Moreover, if the input unit 270 inputs a recording command signal, the control unit 290 controls the still image codec unit 250 to compress a signal of a captured image of a subject, and, if a reproducing command signal is applied, controls the still image codec unit 250 to decompress and display the compressed image signal on the display unit 280.

A method for the control unit 290 to automatically adjust view angles when the image-capturing device 200 is powered on and the image capturing mode is changed will now be described.

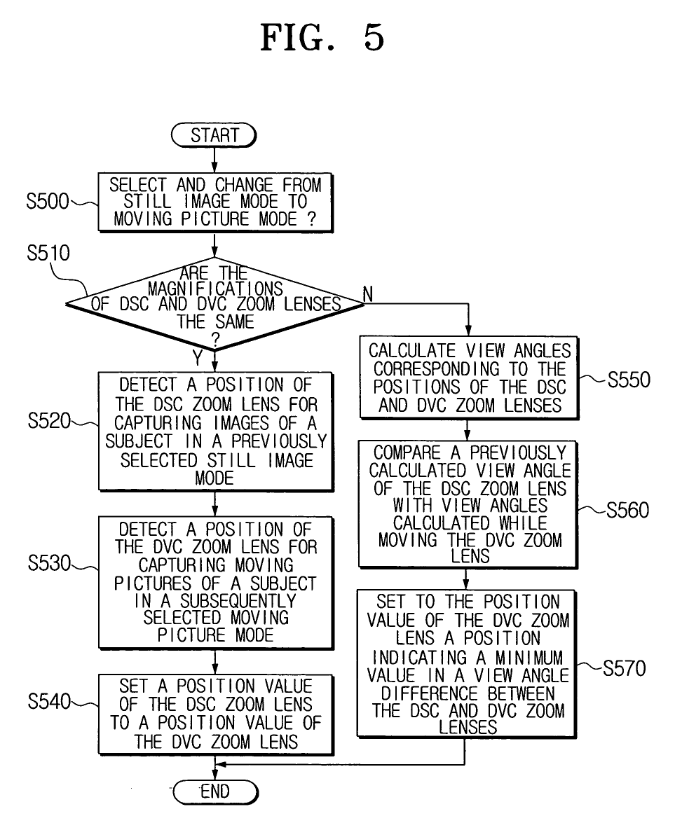

FIG. 5 is a flow chart illustrating a control method for the control unit to adjust image-capturing view angles of the camera when image-capturing modes are changed, as described in FIG. 3.

Referring to FIG. 3 and FIG. 5 for descriptions, if power is applied to the image-capturing device 200 according to an embodiment of the present invention, the control unit 290 determines an image-capturing mode set to the image-capturing device 200 based on a signal received from the mode sensing unit 230. For example, if the still image mode has been selected as an image-capturing mode of the camera part 220 prior to the power-on of the image-capturing device 200, the control unit 290 determines an image-capturing mode of the image-capturing device 200 as the still image mode when power is turned on.

While capturing images of a subject in the still image mode, as a user exchanges cameras capturing images of the subject, that is, turns the camera unit 200 to a certain angle, the mode sensing unit 230 outputs a signal notifying of an image-capturing mode change.

If the image-capturing mode change signal is received by the control unit 290 (S500), the control unit 290 determines whether the magnifications of the DSC zoom lens (not shown) and the DVC zoom lens (not shown) are the same (S510). The DSC zoom lens is a lens provided in the DSC lens unit 222a for capturing images of a subject in the still image mode. The DVC zoom lens is a lens provided in the DVC lens unit 224a for capturing images of a subject in the moving picture mode.

As a result of the determination made in step S510, if the magnifications of the DSC zoom lens and the DVC zoom lens are determined to be the same, the control unit 290 controls the DSC detection unit 222c to detect a position of the DSC zoom lens selected earlier (S520). Further, the control unit 290 controls the DVC detection unit 224c to detect a position of the DVC zoom lens selected later (S530).

After steps S520 and S530 are completed, the control unit 290 compares the positions of the DSC zoom lens and the DVC zoom lens with each other. If the positions are determined to be different from each other, the control unit 290 sets a value of the detected position for the DSC zoom lens selected earlier as a value of the position for the DVC zoom lens selected later (S540). Described in more detail, the control unit 290 calculates a difference between the position value for the DSC zoom lens and the position value for the DVC zoom lens which are detected in the steps S520 and S530, and moves the DVC zoom lens by a difference value.

For example, if the position value of the DSC zoom lens is larger than the position value of the DVC zoom lens, the image-capturing view angle of the DSC zoom lens is smaller than the image-capturing view angle of the DVC zoom lens, so the control unit 290 controls the DVC driving unit 224b to move the DVC zoom lens in a high magnification direction (that is, in a direction in which the view angle becomes smaller) by an amount equal to the calculated the difference value.

If the magnifications of the DSC zoom lens and the DVC zoom lens are decided to be different from each other in the step S510, the control unit 290 calculates image-capturing view angles corresponding to the positions of the previously selected DSC zoom lens and the DVC zoom lens (S550).

If step S550 is completed, the control unit 290 drives the DVC driving unit 224b, sequentially calculates view angles while moving the DVC zoom lens in a certain direction, and compares the sequentially calculated view angles of the DVC zoom lens with the view angle of the DSC zoom lens calculated in advance in the step S550 (S560).

If a position is detected in step S560 that indicates the minimum value in a view angle difference between the DSC zoom lens and the DVC zoom lens, the control unit 290 stops the driving of the DVC driving unit 224b at the position indicating the minimum value, and sets the position indicating the minimum value as a position value of the DVC zoom lens (S570).

Preferably, the combination-type image-capturing device 200 combining the DSC 222 and the DVC 224 as above stores zoom lens position values for an image-capturing mode prior to its power-off or mode changes. By doing so, a user can conveniently use the image-capturing device 200 in case that he or she changes the positions of the DSC 222 and the DVC 224 and then turns on the image-capturing device 200.

Further, the combination-type image-capturing device 200 combining the DSC 222 and the DVC 224 as above can be effectively used in cases where a user wants to capture still images with the DSC 222 in the middle of capturing images of a subject at a certain view angle with the DVC 224. That is, when a user replaces the DVC 224 with the DSC 222 to capture images of a subject, the image-capturing device 200 can eliminate troublesome extra view angle manipulations for the user in order to have the same view angle as that for the DVC 222.

Further, the image-capturing device (not shown) according to another embodiment of the present invention is applicable to a monitoring device (not shown) for monitoring and taking pictures of subjects by using plural cameras, that is, plural zoom lenses. That is, in case that a second monitoring device is used to monitor/take pictures of a subject in the middle of monitoring/taking pictures of the subject through a first monitoring device, a zoom lens position of the second monitoring device is controlled to have a photographing view angle closest to a photographing view angle for the first monitoring device, so that a user does not have to additionally adjust a view angle.

In the image-capturing device and the control method therefor capable of adjusting view angles according to an embodiment of the present invention, when a position of a lens for capturing images of a subject is changed, the image-capturing device can automatically adjust the lens position after the change in order for an image-capturing view angle set for the lens prior to the change to be the same as or close to an image-capturing view angle set for the lens after the change. Accordingly, the view angle is adjusted and kept without users' additional manipulations, so that troublesome extra manipulations can be eliminated that make the view angle the same as before for a subject being image-captured after the lens changes.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An image-capturing device, comprising:
a camera part having a first camera adapted to capture images of a subject at a position of a first zoom lens if a first image-capturing mode is selected and a second camera adapted to capture images of the subject at a position of a second zoom lens if a second image-capturing mode is selected;
a mode sensing unit for sensing an image-capturing mode of the camera part;
a detection unit for detecting the position of the first zoom lens for the first image-capturing mode and the position of the second zoom lens for the second image-capturing mode; and
a control unit for controlling the detection unit to detect the position of the first zoom lens previously selected for the first image-capturing mode and the position of the second zoom lens subsequently selected for the second image-capturing mode if the image-capturing modes are selected and changed from the first image-capturing mode to the second image-capturing mode based on an output signal of the mode sensing unit, comparing the positions of the first and second zoom lenses detected from the detection unit, and, if the positions are determined to be different, setting a value of the position of the first zoom lens to a value of the position of the second zoom lens.

2. The image-capturing device as claimed in claim 1, further comprising a view angle calculation unit for calculating view angles for the positions of the first and second zoom lenses respectively, wherein the control unit decides whether the magnifications of the first and second zoom lenses corresponding to the first and second image-capturing modes respectively are the same, and if they are determined to be different, compares view angles sequentially calculated from the view angle calculation unit with a previously calculated view angle of the first zoom lens while moving the second zoom lens in a certain direction, and sets to a value of the position of the second zoom lens the position indicating a minimum value in a view angle difference between the first and second zoom lenses.

3. The image-capturing device as claimed in claim 1, wherein the first camera is a digital still camera for capturing still images in the first image-capturing mode, and the second camera is a digital video camera for capturing moving pictures in the second image-capturing mode.

4. The image-capturing device as claimed in claim 1, wherein the first and second cameras are disposed opposite to each other.

5. The image-capturing device as claimed in claim 1, further comprising a storage unit, detachably mounted on a main body thereof, for storing an image signal for the subject image-captured through the first and second camera.

6. The image-capturing device as claimed in claim 1, wherein the camera part is provided on a main body thereof to rotate by a certain angle.

7. The image-capturing device as claimed in claim 1, wherein the mode sensing unit senses the image-capturing mode in correspondence to rotations of the camera part.

8. A control method for an image-capturing device including a camera part having a first camera adapted to capture images of a subject at a position of a first zoom lens if a first image-capturing mode is selected and a second camera adapted to capture images of the subject at a position of a second zoom lens if a second image-capturing mode is selected, and provided on a main body thereof to rotate by a certain angle; a mode sensing unit for sensing an image-capturing mode corresponding to rotations of the camera part; a detection unit for detecting the positions of the first and second zoom lenses; a storage unit for storing an image signal for the image-captured subject; and a control unit for controlling the above respective part and units, the method comprising the steps of:
(a) detecting the position of the first zoom lens previously selected for the first image-capturing mode if the image-capturing modes are selected and changed from the first image-capturing mode to the second image-capturing mode based on an output signal of the mode sensing unit;
(b) detecting the position of the second zoom lens subsequently selected for the second image-capturing mode; and
(c) setting a value of the position of the first zoom lens to a value of the position of the second zoom lens if the positions of the first and second zoom lenses detected from the detection unit in the steps (a) and (b) are compared to each other and determined to be different from each other.

9. The control method as claimed in claim 8, further comprising steps of:
(d) if the image-capturing modes are decided to be selected and changed from the first image-capturing mode to the second image-capturing mode based on an output signal of the mode sensing unit, deciding whether the magnifications of the first and second zoom lenses corresponding to the first and second image-capturing modes respectively are the same;
(e) calculating view angles for the positions of the first and second zoom lenses, respectively, if the magnifications of the first and second zoom lenses are determined to be different in the step (d);
(f) comparing sequentially calculated view angles with a previously calculated view angle of the first zoom lens while moving the second zoom lens in a certain direction; and
(g) setting to a value of the position of the second zoom lens the position indicating a minimum value in a view angle difference between the view angle of the first zoom lens and the sequentially calculated view angles of the second zoom lens.

10. The control method as claimed in claim 8, wherein the first camera is a digital still camera for capturing still images in the first image-capturing mode, and the second camera is a digital video camera for capturing moving pictures in the second image-capturing mode.
